(19) United States
(12) Patent Application Publication
(10) Pub. No.: US 2021/0238092 A1
(43) Pub. Date: Aug. 5, 2021

(54) USE OF PREPREGS IN STRUCTURES AS A REINFORCING MATERIAL

(71) Applicant: KORDSA TEKNIK TEKSTIL A.S., Kocaeli (TR)

(72) Inventors: Ozlem TURKASLAN, Kocaeli (TR); Ilhan IZMIT, Kocaeli (TR); Ugur ALPARSLAN, Kocaeli (TR)

(73) Assignee: KORDSA TEKNIK TEKSTIL A.S., Kocaeli (TR)

(21) Appl. No.: 17/049,033

(22) PCT Filed: Dec. 18, 2018
(86) PCT No.: PCT/TR2018/050822

§ 371 Date: Oct. 20, 2020

(30) Foreign Application Priority Data
Apr. 20, 2018 (TR) 2018/05671

(51) Int. Cl. C04B 20/00; C08J 5/24; C04B 20/10; E04C 5/07

(52) U.S. Cl. CPC C04B 20/0068; C08J 5/243; C04B 20/1037; C04B 20/1033; C04B 2111/00612; C08J 2363/00; C08J 2375/04; C08J 2331/02; C08J 2367/00; E04C 5/073

(57) ABSTRACT

A prepreg suitable for use in order to reinforce a concrete or a load bearing material is provided, and the prepreg includes a polymer matrix comprising at least two components, and at least one fiber. The polymer matrix is in a ratio of 50-70% by weight relative to a total weight of the prepreg and the at least one fiber is in a ratio of 30-50% by weight relative to the total weight of the prepreg. Furthermore, the prepreg is used for damaged structures, structures with a modified structural function, or reinforcement in concretes.

### CROSS REFERENCE TO THE RELATED APPLICATIONS

This application is the national stage entry of International Application No. PCT/TR2018/050822, filed on Dec. 18, 2018, which is based upon and claims priority to Turkish Patent Application No. 2018/05671, filed on Apr. 20, 2018, the entire contents of which are incorporated herein by reference.

### TECHNICAL FIELD

The present invention relates to a prepreg suitable for use in reinforcing the structures.

### BACKGROUND

The construction material, which is formed by mixing sand and gravel types known as aggregate homogeneously with cement and water according to manufacture technology with or without adding chemical and mineral additives, is in form of a plastic in the start and gains strength by solidifying and hardening in time, is called concrete. In construction sector, concrete is used as load bearing material, finishing material or for aesthetic purposes. In concretes used as load bearing, the loads applied continuously or discontinuously on the concrete create bending and tensile stresses. The said stresses cases damage in concrete in time, and these damages case the structure to lose its function and risk the safety. The first reinforcement method applied in the technique for this purpose is to place steels known as reinforcement within the concrete in order to compensate loads to be applied on the concrete and the stresses created by these loads, and the state of the concrete integrated with steel is called reinforced concrete. However, the reinforcing method being in steel structure causes problems of the hard and costly maintenance of these steels after corrosion, the steel losing its ductile structure in time and low tensile strength.

In order to prevent problems originating from steel reinforcement in the technique, it is recommended to use composite materials as reinforcing elements in structures. Composite material is a reinforcing member which is formed by combining two or more materials whose properties and chemical components are different from each other and cannot be dissolved in each other in macro scale. Materials that are insoluble in macro scale are resin and fiber forming polymer matrix, and the composite materials formed by combining them separately are used as concrete reinforcing members in structures. One of the techniques used in the application of these composite materials to the structures is hand lay-up application, which is a method of placing the woven formed on the previously prepared mold and overlaying the resin forming the matrix on the fiber by means of simple hand tools such as brush. The composite materials produced with this method are used in automotive, transportation, defense industry, and construction. An example of this is disclosed in Japanese Patent document no JP2000000896A, wherein a composite material manufactured from fabrics woven from glass or aramid fibers and thermoset resins is used as a reinforcing member by hand lay-up. However, even though hand lay-up method has simple process steps, the problems of the applications performed with the said method not being in a standard quality due to errors originating from workmanship, requirement of extra labor, not being able provide homogeneity in whole material, the components within the reinforcing member being excessively corrosive, caustic in case of skin contact and respiration and contaminating arise with the said method.

One of the technologies developed due to the abovementioned disadvantages of composite material produced with had lay-up method in the technique is prepregs. The prepregs are composites which are ready to use by wetting the fibers with resins before and are not hardened. The said composite materials are formed of resin and fiber which is an additive that cannot be dissolved in each other and mixed with each other. While fiber inside the said composite material provides hardness and stiffness to the material, plastic resin material enables the fiber to have integrity, to be connected to each other, the load to be distributed between the fibers, and the fiber to be protected from chemical factors and atmospheric conditions. An example of using prepregs as a reinforcing member for constructions in the state of the art is disclosed in document no JP7111080B. In the document, it is not disclosed which components form the prepreg, application method, and the mechanical properties the concrete has after application.

The reinforcing member used in the documents known in the state of the art could not exhibit the desired performance in terms of use. Namely, the excessively corrosive components in the composite which is a reinforcing member has significant harms to the skin if it is contacted, to respiratory tract if it is respired, and to the environment. Since the fibrous materials among components of composite are applied by hand during wrapping, the gelling time of the resin is exceeded, the quality of the wrapping reduces and the wrapping time increases. The change in the viscosity of epoxy, which is one of the composite components, according to the weather conditions affects the application process and it has been insufficient to standardize the amount of material that is used and to achieve homogeneous wrapping.

### SUMMARY

A prepreg suitable for use in order to reinforce a concrete or a load bearing material is developed with the present invention, and the said prepreg comprises a polymer matrix comprising at least two resins, and at least one fiber.

Furthermore, a prepreg suitable for use in order to reinforce a concrete or a load bearing material is developed with the present invention, the said prepreg is used for damaged structures, structures with modified structural function, or reinforcement in concretes.

By means of the prepreg which developed with the invention and suitable for use in reinforcing concrete or a load bearing material, occupational safety is ensured, application can be made without exceeding gelling time, and therefore high wrapping quality can be achieved. Furthermore, wrapping times being short enables the viscosity of epoxy which is one of composite components not to change due to weather conditions, and thus prevents the application process to be negatively affected. The amount of material that is used is standardized, and homogenous wrapping is achieved. While labor cost is reduced, the quality is increased with the said application.

The objective of the present invention is to develop a prepreg in order to standardize reinforcing property which is gained by the fibers previously wetted with resin.

Another objective of the present invention is to develop a prepreg in order to homogenize the wrapping quality and adhesion state along the column during wrapping.

Yet another objective of the present invention is to develop a prepreg which enables to standardize the wetting amounts of wetted yarns.

Still another objective of the present invention is to develop a prepreg which enables to minimize costs and occupational safety risks by providing labor saving and using materials in optimum amount.

### BRIEF DESCRIPTION OF THE DRAWINGS

FIG. 1 is the view of granulometry graphic formed as a result of test graphic of designing aggregates used in concrete manufacture compatible with EN 1766-2000 standard such that the largest aggregate size will be 16-20 mm.

FIG. 2 is the view of comparison graphic between breaking behavior of concrete samples with prepreg under bending effect and breaking behavior of reference concrete.

FIG. 3 is the view of normal concrete designed as C30 and reinforced concrete sample wound 2 times.

### DETAILED DESCRIPTION OF THE EMBODIMENTS

Concrete which is made of aggregate, cement and water mixture is commonly used as construction material. In time, damage is experienced in concrete due to environmental conditions, the content of the concrete and the disadvantages caused by the application errors. Solutions have been found in the state of the art for the reduction of these damages before or reinforcing the damaged concretes. One of these solutions is to form reinforced concrete by using steel reinforcements in the concrete structures, and thus the concrete is reinforced. However, corrosion of steels in the reinforced concrete, being heavy and low tensile strength are not enough for achieving ductile behavior of the concrete. Another solution for this problem is to develop a composite material manufactured from fiber and polymer resins, the said composite material is applied on the concrete surface with hand lay-up method. However, the composite materials applied with this method not being homogeneous and not being able to provide a standard quality causes them being costly and harmful to the environment. A prepreg suitable for use in reinforcing the concrete or a load bearing material is developed with the present invention.

The prepreg which is developed with the present invention comprises a polymer matrix comprising at least two resins (preferably in ratio of 50-70% relative to the total weight of the prepreg) and at least one giber (preferably carbon) (preferably in ratio of 30-500% relative to the total weight of the prepreg).

Since fiber/resin ratio of the prepreg developed with the present invention, maximum load bearing is achieved in unit material use. The prepreg layers are made ready to be cured upon the application of the prepreg developed with the present invention on the surface of the concrete or a material to be reinforced. The prepreg which is developed is cured with temperature and pressure.

In a preferred embodiment of the invention, the said at least two resins are selected from the group consisting of epoxy, phenolic, polyurethane, vinylester, polyester or combinations thereof.

In another preferred embodiment of the present invention, the said fiber is manufactured from a fiber selected from the group consisting of carbon, aramid, glass, polyester, polyethylene, nylon, polyolefin or combinations thereof. The shelf life of the prepreg that is developed is 1-1 year at −10° C./−20° C. and the operation life under room conditions is 3-6 weeks.

TABLE 1

| Fiber | Fiber | Shelf life (−10° | Operation life |
|---|---|---|---|
| type | content | C./−20° C.)) | under room |
| Carbon, glass, | 50-70% | 1-2 y₁l | 3-6 hafta |
| aramid, nylon, | | | |
| [symbol] | | | |

[symbol]

indicates data missing or illegible when filed

An application of the present invention is shown in Table 2, wherein the said fiber is carbon having 12 k filament number. Furthermore, the strength of the said carbon is 5000 Mpa, and its elasticity modulus is 250 GPa.

TABLE 2

| | Number of | | Elasticity |
|---|---|---|---|
| Yarn | Filaments | Strength | modulus |
| Carbon | 12k | 5000 MPa | 250 GPa |

The prepreg which is developed with the present invention is applied on the concrete surface or on the load bearing material without gap.

The prepreg which is developed with the present invention is used reinforcing constructions with modified structural function or concretes.

In another embodiment of the present invention, the composition of a concrete reinforced with the prepreg is shown in Table 3, wherein the said concrete comprises portland cement (preferably CEM I 42.5 R), water and air. The water/cement ratio of the said portland cement by weight is preferably 0.40-0.65. In addition, the volume of the portland cement is in the range of 49.04-79.62 dm³, and its weight is between 154-250 kg. The specific weight of the cement is 3.14 g/dm³. The amounts used for the production of 1 m³ of concrete wherein the prepreg developed by the present invention is applied, are given in Table 4.

TABLE 3

| | | | DYK, specific | |
|---|---|---|---|---|
| | Water/ | Volume | weight | Weight |
| Material | Grass | [dm3] | [g/dm3] | [kg] |
| CEM I 42.5 R | 0.40-0.65 | 49.04-79.62 | 3.14 | 154-250 |
| Water | | 100 | 1 | 100 |
| Air | | 10-25 | | |

| | |
|---|---|
| Total of partial volume | 159.04-204.62 |

TABLE 4

| | | | DYK specific | |
|---|---|---|---|---|
| | | Volume | weight | Weight |
| Aggregates | % | [dm³] | [g/dm³] | [kg/m³] |
| Sand | 45 | 324.6 | 2.64 | 856.9 |
| Crushed stone no 1 | 25 | 180.3 | 2.65 | 477.8 |
| Crushed stone no 2 | 30 | 216.4 | 2.67 | 577.7 |
| Total volume of aggregates | | 721.3 | | |
| Volume of additives | | 2.5 | | |
| Total volume and weight | | 1000.0 | | 2372.7 |

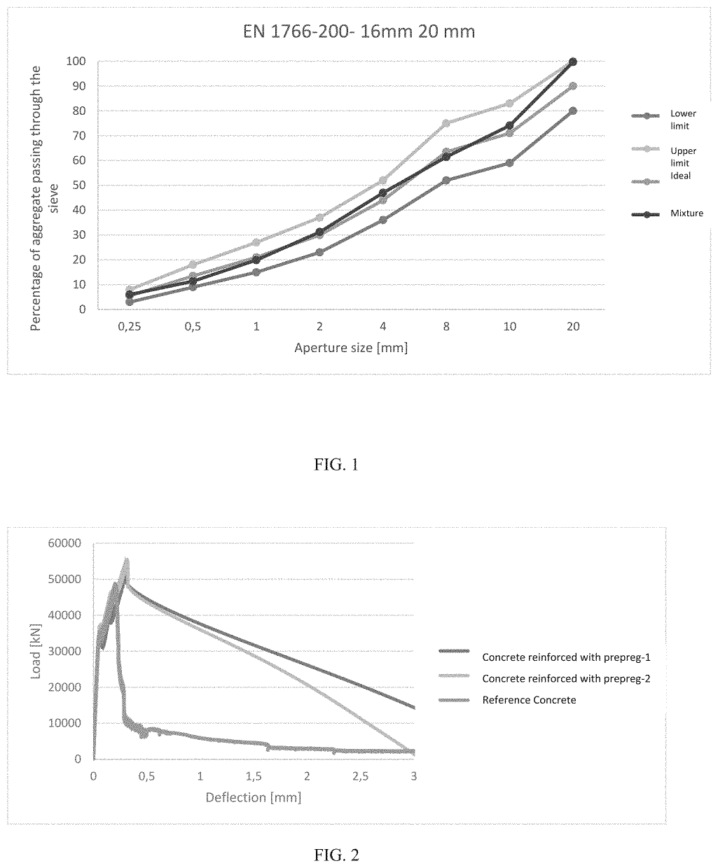

In another embodiment of the present invention, the aggregate properties in the content of a concrete reinforced with the said prepreg were examined, and the obtained results with the experiments are shown in Table 5. Furthermore, the granulometry graphic formed as a result of the test graphic of designing aggregates used in concrete manufacture compatible with EN 1766-2000 standard such that the largest aggregate size will be 16-20 mm is shown in FIG. 1.

TABLE 5

| | Aggregates | | | |
|---|---|---|---|---|
| Sieve, mm | Natural sand | NO1 | NO2 | Mixture |
| 31.5 | 100.0 | 100.0 | 100.0 | 100.0 |
| 22.4 | 100.0 | 100.0 | 100.0 | 100.0 |
| 20 | 100.0 | 100.0 | 100.0 | 100.0 |
| 16 | 100.0 | 100.0 | 97.9 | 99.4 |
| 10 | 100.0 | 95.6 | 10.2 | 72.0 |
| 8 | 100.0 | 64.9 | 2.6 | 62.0 |
| 5.6 | 99.3 | 23.2 | 0.6 | 50.7 |
| 4 | 93.3 | 2.6 | 0.6 | 42.8 |
| 2 | 74.1 | 0.0 | 0.6 | 33.5 |
| 1 | 56.8 | 0.0 | 0.6 | 25.7 |
| 0.5 | 38.5 | 0.0 | 0.6 | 17.5 |
| 0.25 | 20.1 | 0.0 | 0.6 | 9.2 |
| 0.125 | 8.4 | 0.0 | 0.6 | 3.9 |
| Mixture | 45 | 25 | 30 | 100 |

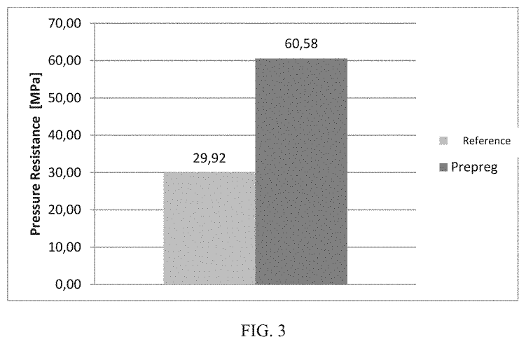

In another embodiment of the present invention, the results obtained as a result of the application of ASTM C1609 (Measuring the flexural tensile strength) test in the beam of a concrete reinforced with prepreg are expressed in Table 6. Samples numbered as 1 and 2 were retrofitted with the same method and materials, and they are casted with same mix design, and the results are aimed to be in a certain value range. In the tests that were performed, sample sizes of the concrete beam were determined as 15*15*50 cm, and the effective span is 45 cm. After this experiment, the behavior of the concrete after the first breaking point (area under the bending-displacement curve) under the tensile effects due to bending and the ductility rate were calculated by using the geometry of the sample. The ductility rate of the concrete reinforced with prepreg is calculated as minimum 74, and the ductility rate of the reference concrete is 20-25. The ductility rate of the concrete applied with prepreg as reinforcing material with the present invention is 3 times of the reference concrete. The comparison graphic of the breaking behavior of the said retrofitted with prepreg concretes under bending effect and the breaking behavior of the reference concrete is shown in FIG. 2. In accordance to this, while the bearing capacity of the reference concrete decreases, the bearing capacity of the concrete reinforced with prepreg is 3 times more than the reference concrete. The average compressive strength tests were performed between the said normal concrete and the concrete reinforced with the prepreg, and the results are given in FIG. 3. The average compressive strength between the twin samples of the concrete designed as C30 has increased from 29.9 MPa to 60.58 MPa.

TABLE 6

| | | | Maximum | Maximum | | |
|---|---|---|---|---|---|---|
| | Breaking | Breaking | load | stress | Area | |
| | load of | stress of | carried by | carried by | below | |
| | concrete | concrete | concrete | concrete | the curve | Duc- |
| | sample | sample | sample | sample | (0-3 mm) | tility |
| No | [kN] | [MPa] | [kN] | [MPa] | [Joule] | rate |
| 1 | 36.95 | 4.93 | 52.15 | 6.95 | 94.11 | 84.89 |
| 2 | 37.49 | 5.00 | 55.30 | 7.37 | 83.55 | 74.27 |

By means of the prepreg which developed with the invention and suitable for use in reinforcing concrete or a load bearing material, occupational safety is ensured, application can be made without exceeding gelling time, and therefore high wrapping quality can be achieved. Furthermore, wrapping times being short enables the viscosity of epoxy which is one of composite components not to change due to weather conditions, and thus prevents the application process to be negatively affected. The amount of material that is used is standardized, and homogenous wrapping is achieved. While labor cost is reduced, the quality is increased with the said application.

What is claimed is:

1. A prepreg suitable for use in order to reinforce a concrete or a load bearing element comprising a polymer matrix, wherein the polymer matrix comprises at least two resins and at least one fiber, and the polymer matrix is in a ratio of 50-70% by weight relative to a total weight of the prepreg and the at least one fiber is in a ratio of 30-50% by weight relative to the total weight of the prepreg.

2. The prepreg according to claim 1, wherein the prepreg is cured with a temperature and/or a pressure.

3. The prepreg according to claim 1, wherein the at least two resins are selected from the group consisting of epoxy, phenolic, polyurethane, vinylester and polyester or combinations of the epoxy, the phenolic, the polyurethane, the vinylester and the polyester.

4. The prepreg according to claim 1, wherein the at least one fiber is manufactured from a fiber selected from the group consisting of carbon, aramid, glass, polyester, polyethylene, nylon and polyolefin, or combinations of the carbon, the aramid, the glass, the polyester, the polyethylene, the nylon and the polyolefin.

5. The prepreg according to claim 1, wherein the at least one fiber is carbon.

6. A prepreg suitable for use in order to reinforce a concrete or a load bearing element, wherein the prepreg is used for reinforcing damaged structures, construction with a modified structural function or concretes.

7. The prepreg according to claim 1, wherein the prepreg is applied on a concrete surface or on a carrier material without a gap.
